(19) United States
(12) Patent Application Publication
(10) Pub. No.: US 2001/0052575 A1
(43) Pub. Date: Dec. 20, 2001

(54) Hand-held anti-counterfeiting apparatus

(76) Inventor: Kevin Mellon, Templeusk (IE)

Correspondence Address: BROWN RUDNICK FREED AND GESMER P C, BOX IP, 18TH FLOOR ONE FINANCIAL CENTER, BOSTON, MA, 02111, US

(21) Appl. No.: 09/769,695

(22) Filed: Jan. 25, 2001

Related U.S. Application Data
(60) Provisional application No. 60/212,863, filed on Jun. 20, 2000.

(51) Int. Cl. G01N 21/64

(52) U.S. Cl. 250/461.1; 356/51; 356/402

(57) ABSTRACT

A new hand-held spectrophotometer-based is provided for identifying and discriminating the presence of labels which provide a characteristic emission spectrum upon illumination and further include algorithms for the analysis of data from a collected spectrum and comparing it against previously stored data to determine whether there is a match.

### FIELD

This invention relates generally to the field of anti-counterfeiting measures and more particularly relates to hand held spectrophotometer based devices, improved algorithms for data interpretation and methods of use.

### BACKGROUND

Throughout history, as soon as any item has been created comprising value, there have been at least one or more attempts to create a simulacrum intended to fool a prospective purchaser or user of the item of value into purchasing it at full value despite its possessing far less value. This activity, commonly referred to as counterfeiting, has cost manufacturers and ultimately consumers vast sums of money. In addition, it has created entire industries whose purpose has been to detect, frustrate or otherwise countermand such illicit activities.

It is an aspect of the present invention to provide new devices capable of more efficiently permitting the discrimination of counterfeit goods from legitimate goods.

A perfect example of the active employment of anti-counterfeiting measures involves modern currency. While wood nickels are easily detected by most people, modern photocopying techniques have unwittingly created greater opportunities for the less skilled to duplicate currency with greater accuracy. In partial response to this threat, governments have attempted to make the sources of critical raw materials difficult to obtain including, for example, the inks and dyes used in printing and the paper used in formulating the currency. In addition, governments have also employed newer techniques of imbedding within the paper “officiating” aspects including ribbons, colored threads, and the like to make the task of counterfeiting as onerous as possible. Still more advanced techniques incorporate multidimensional holographic images and the like. While all of these measures work to some degree, it is another aspect of the present invention to provide additional levels of protection which are not so readily detected by those without specific equipment and even if detected, difficult to reproduce.

In order to be effective, the detection and discrimination of potentially counterfeit items from legitimate ones must be optimally determinable at the location where such objects are readily available. For example, being able to identify counterfeit clothing such as, for example, jeans from those of a well-known and highly respected trademark source will almost necessitate being able to “test” the jeans in question at their source of availability, the store. To do this effectively, one does not wish to alert the storekeeper who could conceivably be part of the counterfeiting operation and this, of course, prohibits visiting the store with bulky equipment. Purchase of the item and its transportation to some other testing site can overcome this impediment. While this may be acceptable with relatively inexpensive and readily transportable jeans, it becomes more problematic with auto parts, pharmaceuticals or valuable comestibles. It also fails to answer the question of whether the entire inventory is counterfeit of just the selected sample.

It is yet another aspect of the present invention to provide apparatus and methods of detection which do not require the purchase of the items in question and more particularly, to provide apparatus and associated detection methods which can be utilized easily in the natural environment of the item.

One manner of tracking objects is to attach thereto a tag or other label which may be detected subsequently by appropriate equipment. Such tags often include fluorescent labels or other dye-like substances which, upon proper illumination, provide a specific pattern or spectrum of light emission. Some of these techniques are used, for example, with currency where a previously imprinted dye is detected with an ultraviolet light, a simple procedure. However, such detection methods are relatively simple to counterfeit in that they qualitatively determine the presence or absence of a label which is itself easily detected. Thus, the counterfeiter can easily determine that currency under UV illumination has one or more areas labelled with a fluorescent dye which he can then paint onto his counterfeit currency to thereby duplicate the effect of the original bill.

It is still another aspect of the present invention to provide apparatus and methods which utilize such labels in a fashion which is not easily duplicated illicitly.

While more complex dyes are available which require specific wavelengths of illumination and which emit or fluoresce at specific spectral frequencies, such substances typically require the use of a spectrophotometer to identify their presence. Spectrophotometers have traditionally been large bench top instruments and are not portable in nature.

It is still another aspect of the present invention to provide apparatus and data handling methods which can be used in the testing field with convenient expediency.

Currently there is available from Microparts an integrated circuit that can perform some spectrophotometric related detection operations. However, the Microparts unit relies upon an external PC or other computerized processing unit, as well as external devices for receiving and handling the optically detected output spectrum. Finally, it also requires externally provided light sources and power supplies and is not designed for convenient, integrated hand-held operation.

It is still yet another aspect to overcome the deficiencies presented by Microparts approach.

There have been some approaches to providing a hand-held spectrophotometer device which have relied upon optical filters to detect the presence of particular wavelengths of emitted light. However, these approaches have been notoriously unreliable in resolution of, and discrimination between emission spectra.

### SUMMARY OF THE INVENTION

The various aspects and principles are addressed with the present invention which provides a hand-held spectrophotometric device capable of providing the necessary illumination to excite one or more light sensitive labels, which upon excitation, emit light at specified frequencies. The hand-held device of the present invention includes a power source, an illumination source, a light emission detector, and a central processing unit capable of interacting with data handling instructions including comparing detected signals against preset conditions to provide a quantitative or qualitative readout with respect to the presence or absence of one or more specific label substances. In addition to basic control features, the apparatus of the present invention may optionally include additional readout ports suitable for communicating real or stored values to other data accumulating or handling devices such as computers, modems, printers and the like.

In addition, the present invention provides novel algorithms for handling the data provided by the optical detector whereby false readouts occurring from spurious background illumination, varying distances to the object being tested, aging or faulty optical detectors and the like are substantially reduced if not eliminated.

### BRIEF DESCRIPTION OF THE DRAWINGS

These and other aspects of the present invention will be better understood by reference to the figures wherein:

FIG. 1 provides a block diagram showing the general electronic construction of major compounds of a hand-held spectrophotometric apparatus of the present invention;

FIG. 2 shows a typical three peak sample spectrum

FIG. 3 shows the three peak spectrum after the 1^{st} derivative operator

FIG. 4 shows the basic mechanical construction of the spectrophotometric optical detector;

FIG. 5 shows sample and reference spectra divided into a grid of rectangles for ZPX analysis;

FIG. 6 shows the Algorithm of the entire check routine;

FIG. 7 shows the Algorithm of the ZPX analysis;

FIG. 8 shows the Algorithm of the ZPX program code;

FIG. 9 shows an incremental step in processing; and

FIG. 10 shows a portion of the computational step of the preferred algorithm.

### DETAILED DESCRIPTION AND BEST MODE

The inventors hereof have surprisingly discovered that it is possible through the present invention to produce a commercially useful, hand-held spectrophotometric-based detection device in accordance with the principles, aspects and discoveries of the present invention.

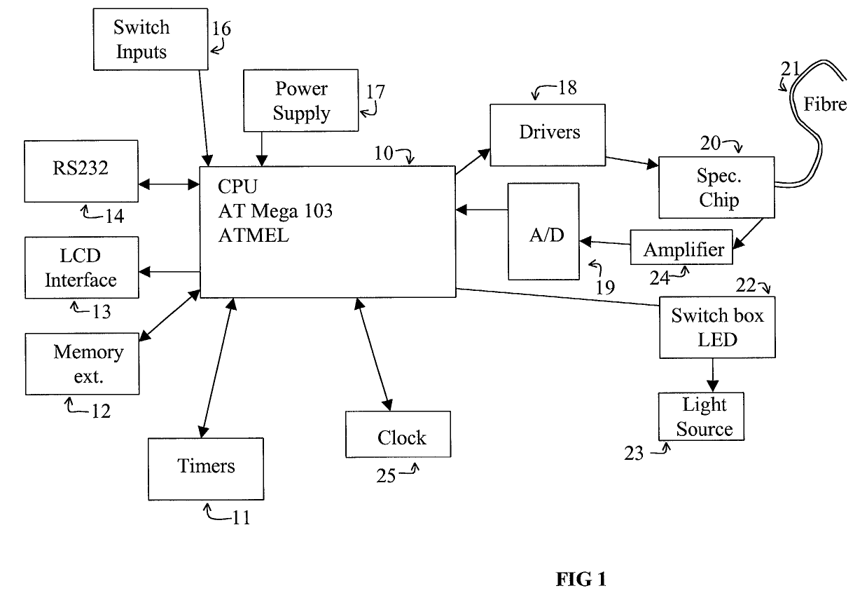

With specific reference to FIG. 1, there is shown an electronic block diagram of the instant invention. At the heart of the device is the central processing unit 10 which controls operation of the device in response to switch inputs 16, instructions from external memory 12 as well as data delivered from the analogue to digital (“A-to-D”) converter 19 via the amplifier 24. A CPU particularly capable of implementing the algorithms described hereafter is the ATMEGA 603/103 available from Atmel(USA). The ATMEGA103 advantageously has an 8 channel, 10 bit A-to-D converter, 128K of ROM 12 which is useful for storage of algorithms and other data handling routines. 4K of RAM can be advantageously used for calculations and additionally, there is 4K of EEPROM which can be advantageously used to store results.

Power supply 17 provides power to the ATMEGA 103 and energizes related peripheral devices including the spectrum processing chip 20, the illumination LED 23, timers 11, external memory 12, and LCD interface 13. Power supply 17 ideally may comprise any of a number of conventional sources of power and while it may rely on externally supplied “wall” power, the preferred embodiment will utilize a battery supply. Optionally, the battery may be of rechargeable type and the power supply 17 may be configured to provide for recharging of the battery given an external power supply or docking station.

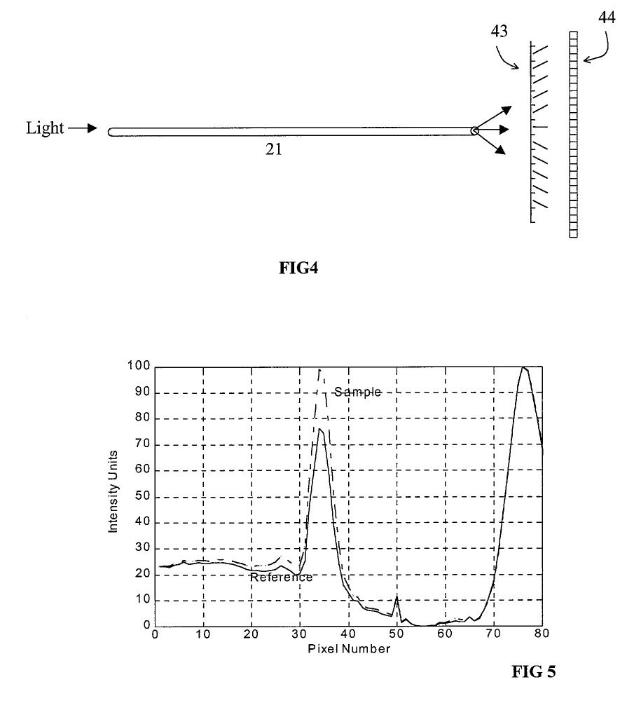

Drivers 18 control spectrometer chip 20 which may be obtained from Microparts, (Germany), Laubscher or Ocean Optics(US). The spectrometer chip collects the spectrum data mechanically as shown in FIG. 4. Fiber optic cable 21 gathers light irradiated from the object being illuminated (not shown) and conveys it to grating 43 which disperses the light into a spectrum of wavelengths, approximately 7 nm apart, which are then conducted to pixels 44. The pixels are light sensitive semi-conductor areas such as a charge coupled device (CCD) and the spectrophotometer chip 20 individually collects the data from the pixels and through A-to-D converter 19 sends the data to CPU 10.

The spectrophotometer chip 20 may be advantageously controlled by periodic timed pulses which first initiate a collection phase during which data accumulates and then terminate the collection phase. The spectrum is spread across 256 pixels with each pixel having a value between 0 and 1,024. These values represent the height of the signal and directly relate to the amount of light impacting the pixel. Each pixel represents a different wavelength. The collecting phase and amplification are set so as to achieve an adequate signal.

In one embodiment of the present invention the spectrophotometer chip 20 is controlled by six separate pulses sent with a specified length and delay relative to each other as stated in the spectrophotometer chip manufacturer specification. All six pulses may be generated by software driven counters in the CPU 10. The pulse lengths may be set using the internal clock while pulse width modulation of the clock provides the relative delays, or alternatively the pulse lengths may be set by the software driven counters in CPU 10. In operation, an initial pulse starts the collection of data with a subsequent pulse acting as a stop signal. Once the start pulse has been sent, the A-to-D under software control will sample and store all the amplified data accumulated since the previous start pulse. The stop signal is ideally generated by software so that integration times can be easily adjusted as necessary. In order to maintain synchronization with the other clock pulses, one of the counters supplied by the ATMEGA 103 may be polled until it reaches a set value at which time a start pulse is sent synchronizing it with all other signals. Once the start pulse has been sent, all data accumulated since the previous start pulse is sent to the A-to-D converter 19 via amplifier 24. Optimally a short initial integration time is used in order to flush any residual signal from the CCD 20 before the actual signal is read at the end of the next start pulse. Similarly, the A-to-D converter 19 can be controlled by polling one of the counters until a set value is reached and then calling the A-to-D converter 19. The digitized value is stored in external memory 12 and the memory address incremented before the next data value is read. This process may be repeated until all CCD pixel locations have been stored.

Returning to FIG. 1, a sample (not shown) is excited by illumination from a light source such as a light emitting diode (LED) 23 which ideally may be controlled by switch 22 for power saving purposes. LED 23 is preferably a UV emitting diode which has a peak emission at approximately 370 nm. Selection of an LED with emissions in this range more readily permits measurement of the reflectance of the substrate or object to be measured. It has been discovered that the physical orientation of LED 23 and fiber optic collection cable 21 is important and is ideally manipulated, optionally with a UV filter, so that the amount of light from the LED 23 which is reflected into fiber cable 21 is minimized while permitting the fiber collection head to be placed as close to the sample as reasonably possible in order to collect a maximal signal. In order to eliminate noise which may be incurred as a result of peculiarities in the spectrometer chip 20 itself, a “dark” reference is taken during which time the fiber optic collection cable 21 is covered. It has also been discovered that with certain highly reflective substrates such as, for example, holograms, the apparent signal strength can be increased by taking a dark reference from an unmarked substrate, (e.g. one without the hologram).

Although spectrophotometer chip 20 ideally provides for a calibrated grating from approximately 380 to 790 nanometers, due to reflectance generally from substrates, a substantial portion of the incident UV from LED 23 is returned directly to the fiber head without alternation. Since this data contains no information, it is ideally discarded and this may be accomplished within the software controlling CPU 10. Accordingly, one embodiment of the present invention advantageously provides for analysis between 410 nanometers and 790 nanometers.

Switch inputs 16 may be directly connected to CPU 10 which reads their status as a binary eight bit number. This permits distinguishing whether one or more buttons are being pressed. Optionally, switch inputs 16 can be expanded to include an alpha numeric key pad interface which would permit greater operator interaction with CPU 10. Switch inputs 16 can be advantageously used to control a menu of operations to be conducted by CPU 10. A library of operations may be stored on the read only memory (ROM) which can be selected and executed. For example, the pressing of one button sends a “high” signal to CPU 10 which then scrolls through the functions from the library of stored functions. These functions may be displayed via LCD interface 13 and the button released when the appropriate function has been displayed. The second button can then initiate the process displayed by that particular function such as initiation of the data analysis algorithm.

Output may be conveniently represented via a liquid crystal display (LCD) through interface 13 which will ideally display, in addition to menu information concerning operation of the device, results of measurement analysis. In order to maintain a convenient size and hand-held dimensions for the present invention, a two line 24 or 16 character LCD may be conveniently used although it is possible for more complex screens to be employed albeit at the expense of size and power consumption.

Additionally, it may be convenient to provide an additional data output method such as, for example, the use of the UART onboard the ATMEL CPU to send/receive information to an RS232 port on any suitable device. The RS232 port offers substantial levels of flexibility and permits a user the option of exporting data to another computing device for further analysis or storage, or to a printer for providing a hard copy. The RS232 port also permits the user to import data to the present invention in order to update the reference data, and/or the library of stored functions.

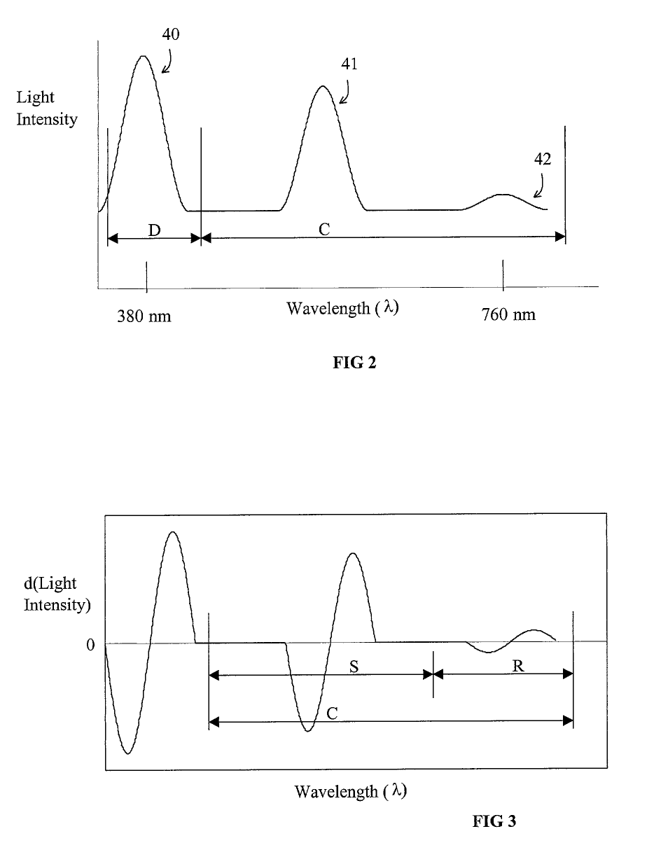

FIG. 2 shows a typical spectrum of light intensity versus wavelength that is collected by the spectrophotometer chip 20 from a sample irradiated by LED 23. The first peak, centered at 370 nanometers, comprises predominately, a reflection component from the light source which has been unchanged by the sample. Essentially this return of scattered light contains little or no information and accordingly, is preferably eliminated in order to improve the signal-to-noise (S/N) ratio. This discarded region is labelled D in the figure. The second peak 41 comprises an emission of light from the sample which is different than that of the light illuminating the sample. The third peak 42 represents a second order diffraction of the primary peak. The information in this peak is preferably included because the ratio of the signal size to this peak provides an indication of the reflectance from the sample. The determination of the amount of reflectance from the sample is useful in identifying the amount of “tail” in the 380 nanometer illumination range which leaks into the collected spectrum C. Thus, information in this peak can assist in identifying and accommodating the output from “noisy” LED's. Further, this peak is useful in detecting the difference between otherwise identical emissions from labels which have been printed on a plastic surface versus a paper surface. Accordingly, data collected over the wavelength range C is analyzed further.

Since each pixel already provides information regarding the wavelength, recall that each pixel typically represents a 3 nanometer change in wavelength from the adjacent pixel, only intensity components are collected. This provides an array [y₁, y₂, y₃ . . . yₙ] where n is the number of pixels in the spectrum array. While this array may be conveniently subtracted from a stored reference array earlier obtained from a known sample, the result of this processing was not found to be adequately reliable for purposes of commercial practicality. This unreliability arose because as the sample was moved increasing distances from the detector fiber 21 (FIG. 1), the signal strength would drop precipitously and the substrate or object could be erroneously rejected as counterfeit. Additionally, the breadth of the peak could easily expand resulting in an inadequate signal to identify a maximum peak.

It was discovered that the signal processing could be improved by taking the first derivative ([y₁−y₂, y₂−y₃, y₃−y₄, . . . yₙ₋₁−yₙ]) of the signal strength from the sample and subtracting it from the first derivative of a stored reference to provide a new array. FIG. 3 demonstrates the results of taking the derivative of light intensity. On this graph, the peaks now occur at the zero crossings and the range of data collected for the sample is shown in the spectrum area labelled C. The sample spectrum representing data that is analysed is labelled S and the spectrum resulting from reflection is labelled R.

In order to further improve the analysis of the sample data, a comparison is made between the absolute value of the positive peak and the negative peak in FIG. 3. The larger peak is set to a value of one and the rest of the curve is normalized by the same factor required to set the larger peak to one. This normalization factor typically varies between zero and a thousand. However, in most situations if the normalization factor is less than ten the sample data collected is rejected as being inadequate due to insufficient signal.

In order to still further improve analysis, a rolling median function is used to smooth the data and this is accomplished by taking the median of three points in a series and rolling this median along the curve. This can be represented as median of (dyₙ₋₁, dyₙ, dyₙ₊₁), This is preferred over taking a normal average because it “eliminates” a spurious peak such as that which may be due to a “stuck” pixel or other noise effect. In addition, it has been found that by taking a rolling median, the noisier result of a first derivative is reduced. This array is then advantageously compared to a reference array which may be stored as a spectrum and then processed similarly. While this approach is preferred because it allows for easier upgrades to the data processing algorithm without necessitating replacement of the stored reference values, one could alternatively store as a reference signal data which has been similarly processed by the data processing algorithm. Subtraction results in an array of values which are differences as a function of wavelength. Each value in the array [delta₁, delta₂, . . . deltaₙ₋₁] is squared to produce a new variance array [delta₁², delta₂², . . . delataₙ₋₁²]. The mean of this array is calculated and this single number called a “match value”. The match value then defines a pass/fail situation which may be compared with a stored match value and may be displayed in a variety of formats including the presentation of the actual numbers, a pass/fail effect or other indicia of acceptability.

The Zero Point Crossing (ZPX) Method for Spectral Comparisons and Other Applications

During the course of our development of the present invention for fluorescent security features, we have sought to identify and use a reliable, computationally compact and versatile method for comparing two emission spectra. For our application, one spectrum (termed a sample) is compared to a representative, averaged spectrum (termed a reference) by the present invention.

For computational purposes, the method must provide a numerical measure of the similarity (or indeed difference) between the sample and reference spectra. Previously, it was found that calculation of the mean variance between the median smoothed, first order spectra provided a good numerical measure of similarity. A difficulty with this approach is its sensitivity to how broad or narrow the spectra are and also the signal-to-noise ratio.

A better method for comparing spectra is described below. This method is called (by the inventors) the “Zero Point Crossing” (ZPX) method. Briefly, the ZPX method involves the following steps:

1. Divide the wavelength or frequency spectrum of both a sample and reference into a grid of rectangles remembering to normalise them both to the same scale (see FIG. 5).

2. Look at each rectangle in the grid in turn and see if the reference spectrum passes through it.

3. Do the same for the sample spectrum.

4. Every time the reference spectrum passes through a particular rectangle, increment the “reference counter”.

5. Whenever the sample and the reference spectra pass through the same rectangle, increment the “agreement counter”.

6. When all of the rectangles have been analysed, divide the agreement counter by the reference counter to obtain a number between 0 and 1.

7. This number represents a similarity or “match” value by which the two spectra may be compared.

A value close to or equal to 0 represents two entirely dissimilar spectra whilst a value close to or equal to 1 represents two very similar spectra.

Principle Benefits of the ZPX Method

1. Flexibility—the size of the rectangles in the grid may be altered to statistically optimise comparison of sample and reference spectra.

2. Sensitivity—the ZPX method is insensitive to the spectral broadness.

3. Computationally efficient—the ZPX method uses a minimal number of floating point operations and is therefore computationally fast, even on slower microprocessors.

4. Cross-comparison—because the ZPX method generates a similarity measure between 0 and 1, no further normalization is required to statistically cross-compare spectra from different materials or readings.

Possible Information Encryption Applications

The ZPX method in one form allows spectra (or similar analogue information of any description) to be used as an encryption key. This works as follows:

1. The dimensions of the spectral grid are defined.

2. The encryption key consists of a series of rectangles through which the reference spectrum passes.

3. Encrypted information may be sent whereby for example, the digits 0-9 correspond to rectangle sides along the wavelength (x) coordinate. The encrypted information takes the form of the equivalent rectangle sides on the signal (y) coordinate, the combination defining a set of rectangles through which the spectrum passes.

4. Decryption may only be achieved with the encryption key i.e. the spectral information; wherein the encrypted positions on the signal (y) coordinate may be mapped back onto equivalent decrypted positions on the wavelength (x) coordinate.

Taking a typical fluorescence spectrum with emission in the visible region, using the spectral resolution of the present invention, we can readily define a useable encryption grid of dimension 60×20 giving 1,200 rectangles through which an encryption key spectrum could possibly pass. This allows for 1 in 20⁶⁰ possible encryption key combinations.

The principle benefit of this approach is that it allows the encryption key to be carried in analogue form. This can take the form of for example biometric readings (voice print, retinal scan, fingerprint etc.), or identity cards with coded fluorescent markings. This means that the encryption key can be as generally or individually available as required and allows easy implementation of information access privilege once the necessary hardware is available to measure the analogue information and suitably digitize it.

Use of the ZPX Method in the Spectral Check Routine

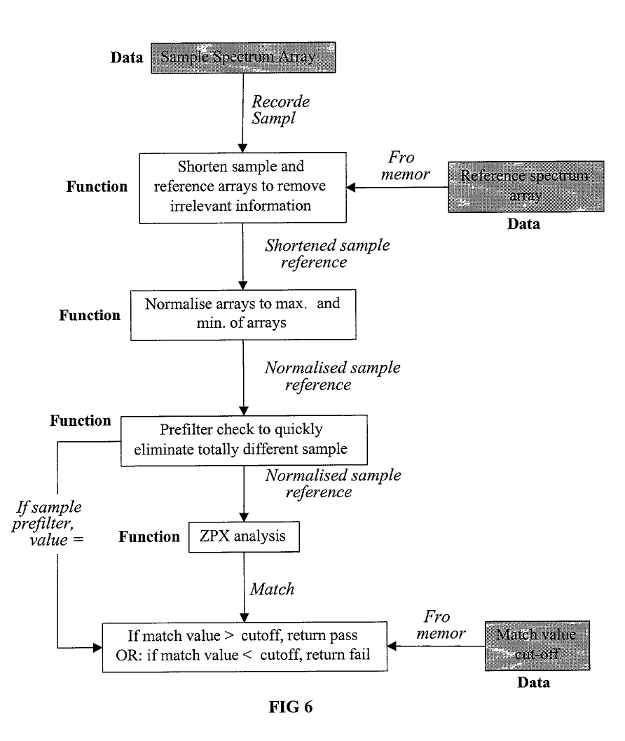

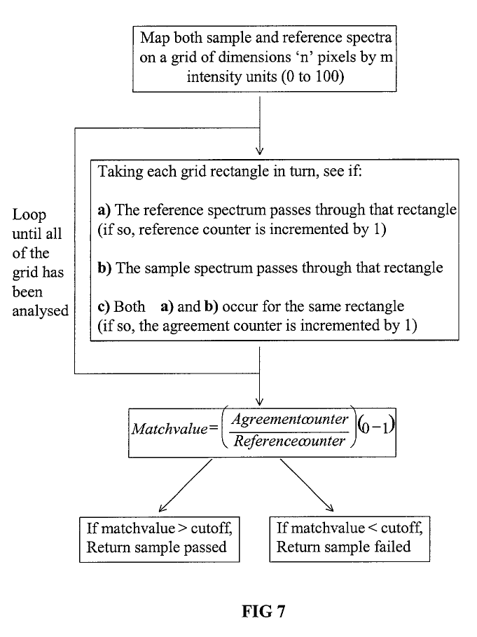

FIGS. 6 and 7 illustrate the entire check routine as used in the present invention. This routine includes several preparation steps prior to ZPX analysis.

The first is a shortening of the sample and reference spectral arrays in order to remove irrelevant spectral information. This removes for example, features arising from light source reflections.

The second step involves normalising the sample and reference arrays to integer values say between 0 and 100. The normalised minimum value in both arrays is set to 0 and the maximum to 100. This step eliminates small differences due to signal size etc.

The third step is a prefilter which is a simple comparison of the position of the peak maximum and broadness of the main features(s) in the sample and reference spectra. If the sample and reference are greatly different, the prefilter rejects the sample and automatically returns a match value of 0 without recourse to the ZPX analysis. This step greatly decreases the average computation time required to compare a large number of spectra.

Finally, if the prefilter does not reject the sample spectrum, the ZPX method calculates the similarity between the former and the reference spectrum, generating the match value as its output.

The match value is compared to a cut-off which is statistically predetermined and a “pass” or “fail” is returned depending on the outcome of this comparison.

The ZPX Computational Algorithm

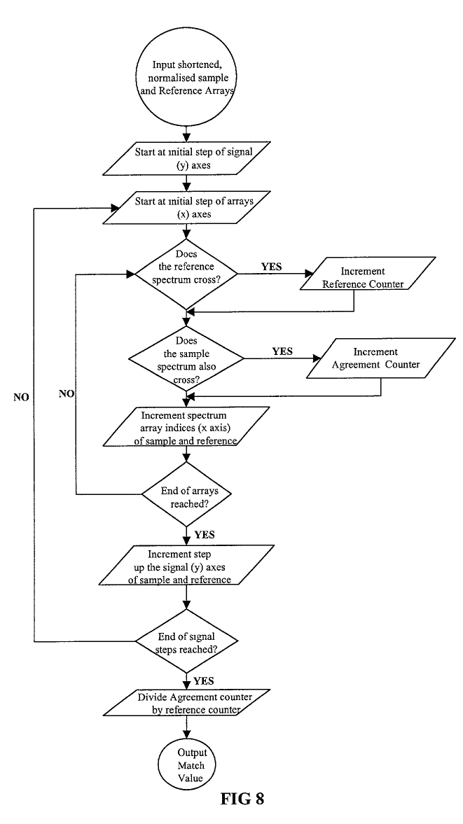

The ZPX algorithm as used computationally is depicted in FIG. 8. Essentially, the computational algorithm works as follows:

1. The input comprises the sample and reference arrays, shortened to the appropriate (but equal) size. These two arrays are linearly normalised such that the minimum value is 0 and the maximum is say 100. It should also be noted that the array consists of integers, minimizing the memory storage required and also allowing fast computation.

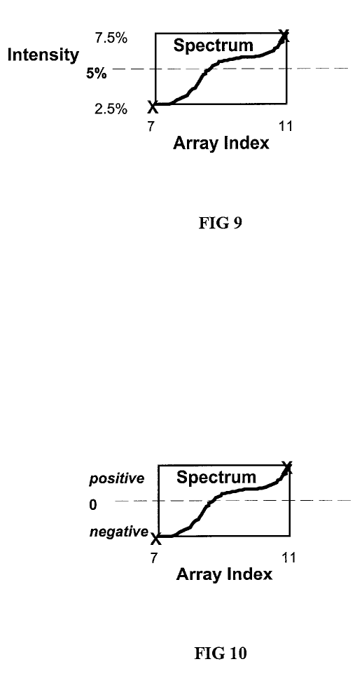

2. A “start step”, “stop step” and “step size” are defined. These parameters control the intensity (y axis) resolution used by the ZPX analysis. For example, if start step is set to 5, stop step to 95 and step size to 10, the analysis will begin 5% up from the bottom of the spectrum and finish at 95%, incrementing upwards in steps of 10%. This essentially defines one dimension of the grid of rectangles used. The other dimension (on the x axis) is controlled in a similar fashion. If for example, we set a start array element of 7 in steps of 4 and set a stop array element of 60, the analysis will begin at the 7^{th} spectral array element, moving along in steps of 4 up to the 60^{th} array element. FIG. 9 depicts the first rectangle in the grid for the figures used in the above example. NOTE: the dimensions of the rectangle on the intensity axis are defined such that the step passes through the center, the height being defined by the step size.

3. The computation begins by setting the intensity (y-axis) start step. In practice, the start step value is subtracted from the entire sample and reference arrays. This has the effect of making the lower values in both arrays negative, leaving the values corresponding to points some way up a peak feature, positive, as shown in FIG. 10.

4. The next step involves moving along the sample and reference arrays pairwise looking for points at which the array elements go from positive to negative or vice versa. The points at which the former occur are referred to as “zero point crossings” (ZPX's) and represent the grid rectangles through which the sample and or reference spectra pass.

5. Every time the reference array produces a ZPX, the reference counter is incremented. At the same time, if a ZPX occurs for the sample array, the agreement counter is also incremented.

6. This process continues until the ends of both the intensity (y axis) step range and the array index (x axis) step range are reached with the entire array index being processes for each step in the intensity range.

7. At this point the step loops are exited, the agreement counter is divided by the reference counter to give the output match value.

ZPX is a new computational method, which has proven to be very effective for comparison of emission spectra. Not only is the method flexible and reliable, but it is also computationally efficient due to the limitation of floating point calculations.

The ZPX method also has potential application not only for comparison of other types of spectra (such as absorption, reflectance etc.) but might also be applied to other comparison computations such as those used in voice, speech or retinal recognition.

The same method could also be adapted to form a unique encryption technique in which the key is effectively analogue information. Again, applications for this might be found in technological areas such as voice print analysis etc.

The hand-held spectrophotometer based analysis of emission spectra from fluorescent labels may be used to detect the presence of one or more of such pigment or dye labels placed upon a sample's label or other associated surface. It will be readily appreciated that as multiple fluorofors, such as those readily available from DuPont, Riedel de Haen of Honeywell Speciality Chemicals and others, are combined, the spectrum resulting from illumination will have increasing degrees of complexity. This complexity will lead to vastly increased difficulty in illegitimate duplication. In addition, it should be noted that the luminous spectrum of any material is unique and that while the emission maxima in the luminous spectrum of two materials may be identical, their profiles are not. This means that the luminous spectrum of any material or mixture of materials represents a unique attribute (or analogue code) of the material or mixture. Thus, known information can be converted into a mixture of luminous materials and stored covertly in a label and can subsequently be decoded by the present invention by use of known protocol or decoding algorithm. This means that rather than identifying a material mixture as merely being present, the material mixture when decoded can provide more details than simply presence. In a manner similar to bar codes, rather than just identifying the presence of black bars on white background as being the sequence looked for, the position and/or thickness may also be used to represent additional data by a known formula.

In addition, the dyes used may be either of organic or inorganic types and will be selected in accordance with the intended object to be labelled, the emissivity spectrum desired and the dye's compatibility with other dyes and labels. While such dyes may be applied directly to labels or other containers associated with the item to be tracked, other applications will require application of the label directly to the item to be tested. In such instances, the labels will need to be selected in order to withstand normal handling during the production, transportation, inventory, and sales cycle. Additionally, the preferred label will be selected to avoid deleterious effects upon the sample item itself.

While a variety of components, connection schemes, data analysis procedures and dye types have been described along with potential uses, those skilled in the art will readily perceive that a great variety of alterations to such components, their connection and use may be made without departing from either the spirit or scope of the present invention.

What is claimed is:

1. A hand-held device for analyzing the presence or absence of a label comprising:
a light source for illuminating the label;
a detector for electronically detecting a spectrum of wavelengths of light emitted by said label upon illumination and providing data representative of the intensity of light detected;
memory storage for providing reference data;
a central processing unit communicating with said detector and said memory storage for analyzing the data provided by the detector and comparing it against said reference data; and
display communicating with said central processing unit for displaying the results of said analysis.

2. The device of claim 1 further comprising a central processing unit control interface for controlling operation of said central processing unit.

3. The device of claim 2 further comprising a power source selected from the group consisting of batteries, rechargeable batteries and a receptacle for receiving externally supplied conventional power.

4. The device of claim 2 wherein said analysis comprises:
mapping said detected light spectrum and said reference data on a grid of rectangles of dimensions n pixels by m intensity units;
on a per grid rectangle basis, incrementing a reference counter if the reference data passes through said rectangle and incrementing an agreement counter if said detected light spectrum passes through said rectangle; and
dividing the value of the agreement counter by the value of the reference counter to derive a match value and if said match value is close to one displaying a result indicating a match or if the match value is close to zero displaying a result indicating the lack of a match.

5. A hand-held device for analyzing the presence or absence of a label comprising;
illumination means for illuminating the label to be analyzed;
detector means for detecting light from said label following illumination;
memory means for providing reference data;
analyzing means for analyzing said detected light and said reference data; and
means for displaying the result of said analysis.
